(19) United States
(12) Patent Application Publication
(10) Pub. No.: US 2008/0032886 A1
(43) Pub. Date: Feb. 7, 2008

(54) Doped solid acid catalyst composition, process of conversion using same and conversion products thereof

(75) Inventors: Chuen Y. Yeh, Edison, NJ (US); Jinsuo Xu, Hillsborough, NJ (US); Philip J. Angevine, Woodbury, NJ (US)

Correspondence Address: DILWORTH & BARRESE, LLP, 333 EARLE OVINGTON BLVD., SUITE 702, UNIONDALE, NY, 11553, US

(73) Assignee: ABB Lummus Global, Inc.

(21) Appl. No.: 11/498,655

(22) Filed: Aug. 3, 2006

(51) Int. Cl. B01J 37/00

(52) U.S. Cl. 502/118

(57) ABSTRACT

A doped solid acid catalyst composition comprising at least one solid acid catalyst, at least one metal promoter for solid acid catalyst (a), at least one basic dopant for solid acid catalyst (a), at least one noble metal; and, optionally, at least one refractory binder.

### BACKGROUND OF THE INVENTION

(1) Field of the Invention

The present disclosure is related to a solid acid catalyst composition, processes of conversion using said solid acid catalyst composition and the conversion products of such processes.

(2) Description of the Prior Art

Solid acid catalysts play an important role in a wide variety of chemical processes, especially in the refining and petrochemical industries. Anion-modified Group IV-B oxides are strong solid acids and have shown promising performance in hydrocarbon conversion processes. In the field of motor fuels, increasingly stringent regulations on aromatics are requiring the refining industry to reduce the content of aromatics, which are conventionally used to boost gasoline octane. Anticipated further, mandated reductions in the aromatics present in gasoline are not likely to be compensated for by simple process adjustments in hydrocarbon production and refining. Thus, different processes and process configurations, along with new catalysts, are now desirable to cope with future motor fuel specifications and requirements.

Skeletal isomerization of straight-chain hydrocarbons into branched, high-octane paraffins has been found to be one effective route to boost octane number and/or to compensate for the octane loss associated with aromatic removal. However, conventional catalysts and traditional acid catalysts cannot isomerize C₇₊ paraffins efficiently, in that C₇₊ paraffins tend to suffer from a substantial amount of undesirable cracking. The cracking of C₇₊ paraffins into low market value, light gas significantly reduces conversion process economics. In addition, any by-product olefins produced in the undesirable cracking of C₇₊ paraffins consume co-fed hydrogen through an undesirable hydrogenation reaction, and still further undesirable cracking contributes to catalyst deactivation via various polymerization reactions.

U.S. Pat. No. 6,767,859 discloses a new type of solid acid catalyst, a catalytic compound of anion-modified metal oxides doped with metal ions. This catalyst, for example, Pt-loaded tungstated zirconia doped with aluminum (designated as Pt/WₐAl_{b}ZrOₓ), has shown unprecedented isomer selectivity in n-C₇ isomerization with less than 10% cracking even at 90% conversion in a vapor phase reactor.

It is economically attractive to convert all n-C₇₊ and mono-branched C₇₊ hydrocarbons into di- or tri-branched C₇₊ hydrocarbons in order to increase their octane number. But due to thermodynamic equilibrium limitations, it is not possible to convert all n-C₇₊ and mono-branched C₇₊ hydrocarbons into di- or tri-branched C₇₊ hydrocarbons in one pass. Additional separation and recycle processes are required to extract di- and tri-branched C₇₊ hydrocarbons, and naphthenes (possibly included in the feed streams) from the product stream. Then the remaining low-octane components of normal- and mono-branched hydrocarbons are recycled into the isomerization reactor to be partially converted to higher octane di- and tri-branched C₇₊ hydrocarbons.

In addition, the undesirable cracking of mono-branched C₇ occurs much more readily than n-C₇ over the same catalyst. Furthermore, undesirable cracking of mono-branched alkanes of higher molecular weight is even more pronounced. In a mixed feed stream, either fresh or recycled, the mono-branched heptanes could exist in the range of 5 weight % to 50 weight % of total heptanes; hence, cracking can be a major problem. Therefore, it is important to further reduce the cracking selectivity of the catalyst to economically enhance the overall isomerization process.

### BRIEF DESCRIPTION OF THE INVENTION

There is provided herein a doped solid acid catalyst composition comprising:

a. at least one solid acid catalyst,

b. at least one metal promoter for solid acid catalyst (a),

c. at least one basic dopant for solid acid catalyst (a),

d. at least one noble metal; and, optionally,

e. at least one refractory binder.

Further, there is also provided herein a process of hydrocarbon conversion comprising:

i) providing a doped solid acid catalyst composition comprising:
a. at least one solid acid catalyst,
b. at least one metal promoter for solid acid catalyst (a),
c. at least one basic dopant for solid acid catalyst (a),
d. at least one noble metal; and, optionally,
e. at least one refractory binder; and,

ii) contacting a hydrocarbon feed with said doped solid acid catalyst composition under conversion reaction conditions, wherein the conversion reaction is selected from the group consisting of isomerization, catalytic cracking, hydrocracking, hydroisomerization, alkylation, transalkylation and combinations thereof.

Still even further there is provided herein a process of making a doped solid acid catalyst composition comprising: combining

a. at least one solid acid catalyst,

b. at least one metal promoter for solid acid catalyst (a),

c. at least one basic dopant for solid acid catalyst (a),

d. at least one noble metal; and, optionally,

e. at least one refractory binder.

Still further there is provided herein a hydrocarbon stream that is treated by the doped solid acid catalyst composition.

### BRIEF DESCRIPTION OF THE DRAWING

FIG. 1 describes the advantage herein, i.e., sodium doped Pt/W—Al—Zr Ox catalysts minimize cracking during the isomerization reaction. All experiments herein were carried out under identical reaction conditions. The solid diamond points represent the base case (bench marking) catalyst, 0.6% Pt/W—Al—Zr Ox, without sodium promotion. The open triangle points represent the base catalyst doped with 92 ppm sodium. The open squire points represent the based catalyst doped with 30 ppm of sodium. In order to compare selectivity, it is only meaningful to compare selectivity at the same extent of conversion, since cracking (or side reaction) increases with increasing extent of conversion. For example, in the isomerization of 3-methylhexane (3MC-6), at 75% conversion, the base catalyst had 10.3 cracking, the 92 ppm Na doped catalyst had 6.7% cracking, and the 30 ppm Na doped catalyst had 6.1% cracking. It is a monobranched heptane (a seven carbon containing paraffin). In 3MC-6, the methyl group is at the 3rd carbon of hexane (a 6 carbon compound), i.e., CH₃CH₂CH(CH₃)CH₂CH₂CH₃. 3MC6 has a greater tendency to crack than n-C7 (normal heptane) and there is 3MC6 in the reactor due to equilibrium distribution and some from a recycle. Further details are described in the “Examples” section below.

### DETAILED DESCRIPTION OF THE INVENTION

There is provided herein doped, solid acid catalyst composition(s) for hydrocarbon conversion processes that are doped with specific basic dopants, which neutralize some of the acid sites on the solid acid catalyst without significantly adversely affecting the overall catalyst activity. In addition, there is provided a process of making doped, solid acid catalyst composition and hydrocarbon conversion processes and hydrocarbon streams that can greatly benefit from the use of these doped, solid acid catalyst compositions.

It will be understood that all specific, more specific and most specific ranges recited herein encompass all subranges there between.

The noble metal that can be used herein can be at least one of any of the noble metals in The Periodic Table that are industrially and/or commercially used in hydrocarbon conversion processes such as preferably the metals in Group VIII and combinations of Group VIII metals. More preferably, the noble metal is at least one metal selected from the group consisting of platinum, palladium, silver, rhodium and iridium, and most preferably is platinum or palladium and combinations thereof. The noble metal herein can also comprise an alloy and/or bimetallic system of any of the foregoing noble metals with at least one other metal such as the non-limiting examples of gold, silver, tin, aluminum, gallium, cerium, antimony, scandium, magnesium, cobalt, iron, chromium, yttrium, silicon, or indium. In one specific embodiment herein, the noble metal is chosen to optimize the catalyst activity and/or selectivity in a hydrocarbon conversion process.

The solid acid catalyst herein can comprise at least one of many conventional catalysts and traditional bifunctional metal/acid catalysts in the mixed metal oxide family such as are industrially and/or commercially used in hydrocarbon conversion processes. In one preferable embodiment, the solid acid catalyst can comprise at least one of the catalysts disclosed in U.S. Pat. Nos. 6,080,904; 6,107,235; and, 6,767,859; the contents of all three patents being hereby incorporated by reference herein in their entirety. In yet a further specific embodiment herein solid acid catalyst can comprise at least one noble metal such as described above with no other noble metal being present in the doped, solid acid catalyst composition besides the noble metal present in solid acid catalyst. In another embodiment, the solid acid catalyst does not comprise a noble metal(s), and the only noble metal(s) is the noble metal(s) which is outside of the solid acid catalyst in the doped, solid acid catalyst composition as described above. In yet still another embodiment, the solid acid catalyst can comprise the same and/or different noble metal, in addition to, the noble metal that is described above which is present in the doped, solid acid catalyst composition. In one other embodiment, the solid acid catalyst can be any catalytic composition of anion-modified metal oxides doped with metal ions, such as the non-limiting example of platinum loaded tungstated zirconia doped with aluminum designated as Pt/AlWZrOₓ as described in U.S. Pat. No. 6,767,859 the contents of which are hereby incorporated by reference in their entirety. In another embodiment the solid acid catalyst can have the formula Pt/AlₐW_{b}ZrOₓ; where a is specifically of from about 0.01 to about 0.5 and more specifically from about 0.02 to about 0.3 and most specifically of from about 0.03 to about 0.2; b is specifically of from about 0.01 to about 0.1 and more specifically from about 0.02 to about 0.05 and most specifically of from about 0.03 to about 0.04; and x is specifically of from about 2 to about 3 and more specifically from about 2.2 to about 3 and most specifically of from about 2.5 to about 2.9.

In one specific embodiment the solid acid catalyst can comprise at least one Group IVA and/or Group IVB metal oxide that has been modified by at least one Group VIA and/or Group VIB metal oxide. The Group IVA and/or Group IVB metal oxide can preferably be at least one oxide of the elements selected from the group consisting of silicon, tin, lead, titanium, or zirconium; and more preferably titanium or zirconium. In a further embodiment the solid acid catalyst can comprise ferric oxide, cerium oxide, and phosphate anion.

In another embodiment herein, the solid acid catalyst is promoted with a metal promoter, wherein the metal promoter is selected from the group consisting of aluminum, gallium, magnesium, cobalt, iron, chromium, yttrium, and combinations thereof. In another specific embodiment metal promoter is a metal oxide of the above-described promoters.

Some specific Group IVB and/or Group VIB metal oxides can be at least one selected from the group consisting of WOₓ, and MoOₓ. It will be understood herein in one embodiment that promoter, Group IVA and/or Group IVB metal oxide and Group VIA and/or Group VIB metal oxide can each be separate and different metal oxides.

The Group IVB and/or Group VIB metal oxide can preferably be at least one oxide of the elements selected from the group consisting of chromium, molybdenum, or tungsten; and more preferably molybdenum or tungsten. Some specific Group IVB and/or Group VIB metal oxides can be at least one selected from the group consisting of WOₓ, MoOₓ. The modification of at least one Group IVA and/or Group IVB metal oxide with at least one Group IVB and/or Group VIB metal oxide can be accomplished through procedures known to those skilled in the art such as the non-limiting example of impregnating at least one Group IVB and/or Group VIB metal oxide onto at least one Group IVB and/or Group IVB metal oxide followed by calcination at elevated temperatures. In addition, conventional methods of coprecipitation known to those skilled in the art can also be used to modify at least one Group IVB and/or Group IVB metal oxide with at least one Group IVB and/or Group VIB metal oxide. One non-limiting example of coprecipitation that can be used herein can comprise mixing zirconia oxychloride solution with aluminum chloride solution at a PH of greater than about 9 (adjusted with ammonium hydroxide). The co-precipitated material can then be washed, as it was in Example 1 below, several times to get rid of chloride ion and dried at 120° C. Then, a calculated amount of ammonium metatungstate solution can be added via incipient wetness technique, followed by calcining.

In one specific embodiment the solid acid catalyst can comprise at least one sulfated metal oxide, such as the metal oxides described above that has been impregnated by ammonium sulfate solution, dried, and calcined. The sulfated solid acid catalyst is selected from the group consisting of sulfated zirconium dioxide, sulfated titanium dioxide and sulfated tin dioxide.

In one other specific embodiment, the solid acid catalyst can also comprise any zeolite or combination of zeolites. Preferably, the zeolite can be at least one zeolite that has been industrially and/or commercially used in hydrocarbon conversion processes. Aluminosilicate zeolites are microporous, crystalline materials composed of AlO₄ and SiO₄ tetrahedra arranged around highly ordered channels and/or cavities. Zeolites are acidic solids, in which protons required for charge balance of the framework generate surface acidity and are located near the Al cations. More generally referred to as molecular sieves, these materials have structural properties desirable for solid acid catalysts, such as surface acidity, high surface areas, and uniform pore sizes. Some non-limiting examples of zeolites used as catalysts in hydrocarbon conversion processes like petroleum refining include Pt/mordenite for C₅/C₆ isomerization, ZSM-5 for xylene isomerization and methanol-to-gasoline conversion, sulfided NiMo/faujasite for hydrocracking of heavy petroleum fractions, and USY for fluidized catalytic cracking. Zeolites which are also used for other acid-catalyzed processes can be used herein. A nonlimiting list of relevant aluminosilicate zeolites includes mordenite, zeolite X, Zeolite Y (and USY), ZSM-5 (including so-called “silicalite”), ZSM-11, ZSM-12, ZSM-20, ZSM-22 or Theta-1, ZSM-23, ZSM-34, ferrierite, ZSM-35, ZSM-48, ZSM-57, MCM-22, MCM-49, and MCM-56. Other zeolites include TS-1, TS-2, TS-Beta, TS-48, AMS-5, SAPO-5, SAPO-11, and SAPO-34.

In yet another embodiment herein solid acid catalyst can comprise at least one chlorided alumina catalyst. Preferably, chlorided alumina catalyst can be at least one chlorided alumina catalyst that is industrially and/or commercially used in hydrocarbon conversion processes. For example, the bifunctional Pt-doped chlorided alumina catalyst used in the n-butane isomerization process can be used.

In yet still another embodiment herein, the solid acid catalyst can be doped with a basic dopant, which neutralizes a sufficient number of the strong acid sites in order to provide beneficial physical and/or processing effects such as the non-limiting example of reducing the cracking function of the solid acid catalyst in a hydrocarbon conversion process. The basic dopant can be any composition or compound that will capable of neutralizing a sufficient amount of strong acid sites to provide for beneficial physical and/or processing effects. The basic dopant (a Na-equivalent basis) level is low compared to the total acidic sites, for example a level of specifically 5 to 500 ppm, more specifically 10 to 200 ppm and most specifically 15 to 100 ppm.

By controlling the amount of dopant, solid acid catalyst composition can be optimized for activity and selectivity in any process and preferably in a hydrocarbon conversion process. Quite often, the catalyst is subdivided into a nanocomposite structure, i.e. having ultimate domain sizes less than 100 nm. Nanocomposite processing provides for an ultrahigh dispersion of components, allowing for the effective dispersion of dopant ions within the solid acid catalyst. The resulting doped, solid acid catalyst composition allows for low temperature hydrocarbon conversion processes. In addition, a doped, solid acid catalyst composition, as described herein, can provide for negligible catalyst deactivation over time. In yet a further specific embodiment herein, basic dopant can comprise in addition to the dopant described herein, noble metal as described above. When the doped catalyst comprises a noble metal, there can be at least one additional equivalent and/or different noble metal present in the doped, solid acid catalyst composition. In one other embodiment, the basic dopant can comprise noble metal with no additional equivalent and/or different noble metal being present in the doped solid acid catalyst composition. In yet a further specific embodiment, additional noble metal can be different from any other noble metal present. Furthermore, the basic dopant can be incorporated into the solid acid catalyst in the same and/or similar manner as at least one Group IVB and/or Group VIB metal oxide is modified by at least one Group IVB and/or Group VIB metal oxide, such as is described above. For example, the basic dopant can be incorporated into the solid acid catalyst by impregnation of the basic dopant followed by calcinations.

As described above, the basic dopant can be at least one alkaline oxide and/or alkaline earth oxide, which can be selected from the group consisting of lithium oxide, sodium oxide, potassium oxide, cesium oxide, magnesium oxide, calcium oxide, strontium oxide, barium oxide and combinations thereof. In another specific embodiment, the basic dopant can be oxygen-containing compounds selected from the group consisting of sodium nitrate, sodium carbonate, sodium bicarbonate, potassium nitrate, calcium carbonate, and magnesium carbonate.

In one other embodiment, basic nitrogen compounds can be used as dopant to reduce the small portion of “strong” acid sites present in the catalyst to result in a minimization of undesirable hydrocarbon cracking. Some specific examples of suitable organic amines can be small (molecule) alkylamines, such as methyl amine, ethylamine or even ammonia or ammonium hydroxide.

The amount of basic dopant in the doped, solid acid catalyst composition suitable for the uses described herein can vary greatly depending on the particular basic dopant, and its required effect on selectivity and activity for the hydrocarbon conversion processes. The basic dopant is generally present in the solid acid catalyst in an amount that will provide for less cracking in a process of hydrocarbon conversion than a solid acid catalyst in an equivalent process of hydrocarbon conversion that does not contain the basic dopant. Preferably, the amount of basic dopant can be less than about 100 ppm in the solid acid catalyst, more preferably less than about 75 ppm, even more preferably less than about 50 ppm and most preferably less than about 35 ppm. In one further embodiment, the amount of basic dopant can be about 30 ppm or less. It will be understood herein that there must be at least an effective amount of basic dopant in solid acid catalyst when it is doped, so that the amount of basic dopant present is greater than zero, subject to the above ranges.

The doped, solid acid catalyst composition herein can further comprise a refractory binder. The binder can be any binder or support as is commercially and/or industrially used by those skilled in the art of solid acid catalysis. The preferred binder is selected from the group consisting of fumed silica, colloidal silica, precipitated silica and combinations thereof. While not limiting, other binder components can include alumina, silica-alumina, zirconia, or combinations thereof.

The doped, solid acid catalyst composition can be in any form that would be advantageous to the end user. In one embodiment, the doped, solid acid catalyst composition is in a particulate and/or shaped form, wherein the shaped form is an extrudate, pellet, ring, or other conventional shape and particulate form is a powder and/or crushed form.

In one embodiment herein, the doped, solid acid catalyst composition can include differing amounts of noble metal, solid acid catalyst, promoter and dopant. The amount of noble metal can be varied to optimize processing of hydrocarbons in conversion processes. Preferably the amount of noble metal is of from about 0.05 to about 2.0% weight, more preferably of from about 0.1 to about 1.0% by weight, and most preferably of from about 0.2 to about 0.8% by weight, based on the total weight of the doped, solid acid catalyst composition. The amount of solid acid catalyst can be varied to optimize processing of hydrocarbons in conversion processes. Preferably the amount of solid acid catalyst can be of from about 10 to about 98% parts by weight, more preferably of from about 40 to about 90% by weight, and most preferably of from about 50 to about 80% by weight, based on the total weight of the doped solid acid catalyst composition, including binder.

In another specific embodiment herein, the hydrocarbon conversion process comprises:

i) providing a doped, solid acid catalyst composition comprising:
a. at least one solid acid catalyst,
b. at least one metal promoter for solid acid catalyst (a),
c. at least one basic dopant for solid acid catalyst (a),
d. at least one noble metal; and, optionally,
e. at least one refractory binder; and,

ii) contacting a hydrocarbon feed with said doped, solid acid catalyst composition under conversion reaction conditions, wherein the conversion reaction is selected from the group consisting of isomerization, catalytic cracking, hydrocracking, hydroisomerization, alkylation, transalkylation and combinations thereof. In one specific embodiment, the conversion process, such as for example, isomerization, results in less cracking that an equivalent process of conversion that comprises contacting a hydrocarbon feed with a solid acid catalyst other than doped, solid acid catalyst composition. The doped, solid acid catalyst composition can be used in hydrocarbon conversion reactions such as those conversion reactions described above. In one embodiment, the hydrocarbon conversion process can comprise where the hydrocarbon feed is a mixed stream of hydrocarbons, preferably a mixed stream comprising monobranched and normal hydrocarbons (paraffins). In one embodiment said mixed stream can comprise a mixed refining and/or distillation stream. In another specific embodiment said mixed stream can be a fresh stream or a recycled stream. In one other embodiment hydrocarbon feed can comprise C₇₊ alkanes, preferably monobranched and normal C₇₊ alkanes, more preferably monobranched and normal C₇ and/or C₈ alkanes and most preferably monobranched and normal heptane. Preferably the doped, solid acid catalyst composition can be used for the isomerization of straight chain alkanes, more preferably C₇₊ alkanes, and most preferably heptane and/or octane. Cracking can be undesirable when such cracking of a hydrocarbon produces fractions that would be inefficient (i.e. low-valued products) and/or not usable for transportation fuels. Some non-limiting examples of fractions that would be inefficient and/or not usable are butane, isobutane, propane, ethane, and methane. Preferably herein, the hydrocarbon conversion process results in less than about 30% of the cracking that is present in an equivalent hydrocarbon conversion process using a solid acid catalyst other than a doped, solid acid catalyst composition. More preferably herein hydrocarbon conversion process results in less than about 20% of the cracking that is present in an equivalent hydrocarbon conversion process using a solid acid catalyst other than a doped, solid acid catalyst composition. Even more preferably herein, hydrocarbon conversion process results in less than about 10% of the cracking that is present in an equivalent hydrocarbon conversion process using a solid acid catalyst other than a doped, solid acid catalyst composition. Most preferably, herein hydrocarbon conversion process results in less than about 5% of the cracking that is present in an equivalent hydrocarbon conversion process using a solid acid catalyst other than a doped, solid acid catalyst composition. In one specific embodiment herein, the hydrocarbon conversion process can result in an isomerized product such as a motor gasoline (“mogas”) pool with an increased octane number. In one embodiment herein there is provided a hydrocarbon conversion product (an isomerized product) of a hydrocarbon conversion process wherein the hydrocarbon conversion product (i.e., isomerized product) has at least one of a reduced pour point, cloud point, or freeze point such as the non-limiting examples of hydrocarbon conversion product and/or streams wherein the hydrocarbon product is most specifically intended for jet, diesel or lube applications. A reduced pour point, cloud point, or freeze point comprises a pour point, cloud point, or freeze point that is lower than a pour point, cloud point, or freeze point in an equivalent hydrocarbon conversion process that does not utilize doped solid acid catalyst composition described herein. In a more specific embodiment any one or more of reduced pour point, cloud point, or freeze point can have a reduction of specifically at least about 20° F. more specifically 15° F. and most specifically 10° F. compared to such an equivalent hydrocarbon conversion process. In yet another embodiment herein, the hydrocarbon feed can be a Fischer-Tropsch process product. In yet even another specific embodiment, there is provided a hydrocarbon feed or recycle stream comprising soluble or suspended doped, solid acid catalyst at a concentration suitable for reducing cracking of the hydrocarbon feed.

In an even more specific embodiment, the doped, solid acid catalyst composition can be used in an isomerization reaction with preferably greater than about 50% conversion, more preferably greater than about 60% conversion and most preferably greater than about 90% conversion. In another specific embodiment, the doped, solid acid catalyst composition can be used in an isomerization reaction with preferably greater than about 50% selectivity, more preferably greater than about 70% selectivity and most preferably greater than about 90% selectivity. The doped, solid acid catalyst composition herein allows for low temperature hydrocarbon conversion processes, such as those which can be conducted at preferably less than about 250° C., more preferably less than about 165° C., and most preferably less than about 125° C.

In another embodiment herein there is also provided a process of making a doped, solid acid catalyst composition comprising: combining
a. at least one solid acid catalyst,
b. at least one metal promoter for solid acid catalyst (a),
c. at least one basic dopant for solid acid catalyst (a),
d. at least one noble metal; and, optionally,
e. at least one refractory binder.

The examples below are given for the purpose of illustrating the invention of the instant case. They are not being given for any purpose of setting limitations on the embodiments described herein.

### EXAMPLES

The catalyst performance was evaluated in a 3-methylhexane isomerization reaction. The reaction was conducted in a fixed-bed reactor. The catalyst was in powder form (˜140 mesh). The amount of catalyst sample (active WAlZrOₓ) was maintained at about 500 mg per test. The catalyst was loaded into a ½″ o.d. quartz tube reactor with a thermocouple located right below the catalyst bed. The catalyst was heated in flowing He with a 5° C./minute heating rate up to 400° C. and held there for 12 hours. Then the reactor was cooled down to 200° C. He flow was then replaced with H₂ flow, and the catalyst was reduced in H₂ at 200° C. for at least 90 minutes. Then a feed gas containing 3 mole % of 3-methylhexane (3M-C₆) in H₂ was introduced into the reactor. The reaction products were analyzed by an on-line gas chromatograph with FID detector and 60-meter long DB-5 capillary column (Model number: J&W SN3298522). The first product was taken 15 minutes after the feed was introduced.

Subsequent samples were analyzed at 45-60 minute intervals. The catalyst activity and cracking selectivity were calculated from the peak areas of products and the reactant according to the following equations.

Conversion (%)=[(sum of peak areas of all products)/(sum of peak areas of all products+unconverted 3MC₆ peak area)]*100.

Cracking Selectivity (%)=[(sum of peak areas of hydrocarbons with less than 6 carbon atoms)/(sum of peak areas of all products)]*100.

### Example 1

### Preparation of Tungstated Al-doped Zirconia (WAlZrOₓ)

A mixed Zr—Al hydroxide was prepared by co-precipitation of 13 parts of ZrOC₁₂.8H₂O, 0.75 parts of Al(NO₃)₃.9H₂O and 80 parts of 14 wt % of ammonium hydroxide solution under a constant pH of 9-10. The mixed-hydroxide precipitate was washed at least four times with distilled water. After drying the precipitate at 100° C. to 120° C., the filter cake was pulverized into fine powders. Following the impregnation of 8.4 parts of 22.4 wt % ammonium metatungstate [(NH₄)₆H₂W₁₂O₄₀] solution over the fine hydroxide, the mixture was dried at 100-120° C. and then calcined at 800° C. for 3 hours. This final product was a yellowish powder and was called tungstated Al-doped zirconia (designated as WaAl_{b}ZrOₓ).

### Example 2

### Silica-Bound WAlZrOₓ

A fumed silica (AEROSIL200) was obtained from Degussa Corporation. Two hundred forty (240) parts of WAlZrOₓ prepared according to Example 1 was mixed with 60 parts of AEROSIL silica, and a proper amount of de-ionized water (around 150 parts). The mixture was mixed in a mixing device thoroughly, and then transferred into the cylinder of a hydraulics extruder (Loomis Ram Extruder, Model 232-16) followed with extrusion into 1/16″ diameter extrudates. The extrudates were calcined under the following conditions: static air, 90° C. for 1 hour; 120° C. for 1 hour, raised to 450-500° C. with a heating rate of 5° C./min and held for 5 hours, and then cooled to room temperature.

### Example 3

### Preparation of Tungstated Al-Doped Zirconia Extrudates with Pt (0.6% Pt/WAlZrOₓ)

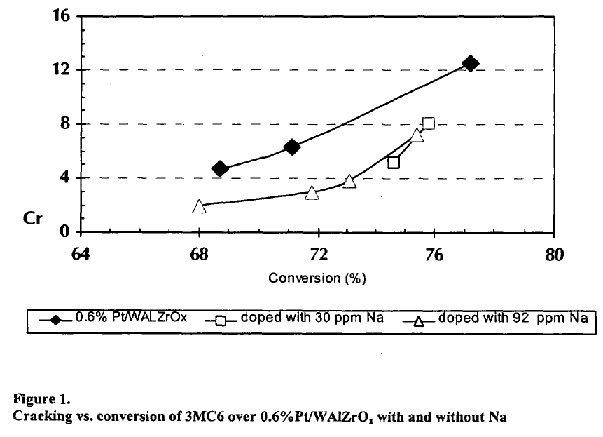

18.0 parts of the material obtained from Example 2 was impregnated with 6.21 parts of 1.74 wt % of (NH₃)₄Pt(NO₃)₂ aqueous solution. After calcination at 350° C. for 3 hours and then 450° C. for 3 hours, the platinum salt decomposed into platinum oxide. The sample was designated as 0.6 wt % Pt/AlₐW_{b}ZrOₓ and used for the performance test. The results are shown in Table 1 and FIG. 1.

### Example 4

### Modification of Tungstated Al-Doped Zirconia Extrudates with 30 ppm Na (AlₐW_{b}ZrOₓ₋30Na)

The Na salt used here is NaNO₃ from Aldrich. An aqueous solution containing 1 mg NaNO₃/ml was prepared. 2.0 parts of extrudate from Example 2 was impregnated with a mixed solution of 0.222 parts of 1 mg NaNO₃/ml solution and 0.78 parts of deionized water. Then the impregnated sample was dried at 120° C. and calcined at 500° C. for 3 hours to allow the decomposition of NaNO₃ into Na₂O.

### Example 5

### Preparation of AlₐW_{b}ZrOₓ-30Na with Pt (0.6% Pt/AlₐW_{b}ZrOₓ-30Na

18.0 parts of the material obtained from example 4 was impregnated with 6.21 parts of 1.74 wt % of (NH₃)₄Pt(NO₃)₂ aqueous solution. After calcination at 350° C. for 3 hours and then 450° C. for 3 hours, the platinum salt decomposed into platinum oxide. The sample was designated as 0.6% Pt/AlₐW_{b}ZrOₓ-30Na and used for performance test. The results are shown in Table 1 and FIG. 1.

### Example 6

### Modification of Tungstated Al-Doped Zirconia Extrudates with 92 ppm Na (AlₐW_{b}Oₓ-92Na)

The Na salt used here is NaNO₃ from Aldrich. An aqueous solution containing 1 mg NaNO₃/ml was prepared. 6.0 Parts of extrudates from Example 2 were impregnated with a mixed solution of 2.02 parts of 1 mg NaNO₃/ml solution and 1.0 parts of deionized water. Then the impregnated sample was dried at 120° C. and calcined at 500° C. for 3 hours to allow the decomposition of NaNO₃ into Na₂O.

### Example 7

### Preparation of AlₐW_{b}ZrOₓ-92Na with Pt (0.6% Pt/AlₐW_{b}ZrOₓ-92Na)

18.0 parts of the material obtained from Example 6 was impregnated with 6.21 parts of 1.74 wt % of (NH₃)₄Pt(NO₃)₂ aqueous solution. After calcination at 350° C. for 3 hours and then at 450° C. for 3 hours, the platinum salt decomposed into platinum oxide. The sample was designated as 0.6 wt % Pt/AlₐW_{b}ZrOₓ-92Na and used for a performance test. The results are shown in Table 1 and FIG. 1.

A catalyst performance test was carried out for samples prepared from Examples 3, 5, and 7. The test results of all catalysts were listed in Table 1 and FIG. 1.

TABLE 1
Conversion and cracking selectivity of 3MC₆ over different catalysts

| | | | Conversion* | C6 Selectivity* |
|---|---|---|---|---|
| Catalyst | Dopant | WHSV* (h⁻¹) | (%) | (%) |
| 0.6% Pt/AlₐW_{b}ZrOₓ | None | 0.77 | 77.2 | 12.5 |
| 0.6% Pt/AlₐW_{b}ZrOₓ30Na | 30 ppm Na | 0.77 | 74.6 | 5.2 |
| | added to | | | |
| | WAlZrOₓ | | | |
| 0.6% Pt/AlₐW_{b}ZrOₓ-92Na | 92 ppm Na | 0.77 | 68.0 | 2.0 |
| | added to | | | |
| | WAlZrOₓ | | | |
| 0.6% Pt/AlₐW_{b}ZrOₓ-92Na | Coating of | 0.77 | 72.4 | 2.9 |
| | 1% Fe₂O₃ | | | |

*Other test conditions: T = 200° C., P = 1 atm, H2/C7 molar ratio ≈33. The test data at weight hourly space velocity (WHSV) of 0.77 h⁻¹ were collected around 110–140 minutes of time on stream.

It is clear that the catalyst doped with Na had much lower cracking during the isomerization of 3MC₆, as shown in Table 1. Under the same conversion, as shown in FIG. 1, the Na-doped catalyst had one-half of the cracking compared to the unmodified catalyst.

The doping of Na at high level could reduce the catalyst activity as seen from 3MC₆ conversion at the same space velocity in Table 1. Nevertheless, when an optimal amount of modifier is applied, a noticeable improvement was observed regarding catalyst activity with no detrimental effect in cracking. For example, the catalyst doped with 30 ppm of Na had almost same activity and only one-half of cracking compared to the unmodified catalyst.

In one specific embodiment in this disclosure it will be understood that while the above description comprises many specifics, these specifics should not be construed as limitations, but merely as exemplifications of specific embodiments thereof. Those skilled in the art will envision many other embodiments within the scope and spirit of the description as defined by the claims appended hereto.

What is claimed is:

1. A doped, solid acid catalyst composition comprising:
a. at least one solid acid catalyst,
b. at least one metal promoter for solid acid catalyst (a),
c. at least one basic dopant for solid acid catalyst (a),
d. at least one noble metal; and, optionally,
e. at least one refractory binder.

2. The doped, solid acid catalyst composition of claim 1 wherein at least one solid acid catalyst is selected from the group consisting of a Group IVB and/or Group IVB metal oxide modified by a Group IVB and/or Group VIB metal oxide, a sulfated metal oxide, acidic zeolite, a chlorided alumina and combinations thereof.

3. The doped, solid acid catalyst composition of claim 2 wherein the Group IVB and/or VIB metal oxide is at least one oxide of the elements selected from the group consisting of silicon, tin, lead, titanium, or zirconium.

4. The doped, solid acid catalyst composition of claim 1 wherein the Group IVB and/or Group VIB metal oxide is at least one oxide of the elements selected from the group consisting of chromium, molybdenum, or tungsten.

5. The doped, solid acid catalyst composition of claim 1 wherein the metal promoter is at least one metal selected from the group consisting of aluminum, gallium, magnesium, cobalt, iron, chromium, yttrium, and combinations thereof.

6. The doped, solid acid catalyst composition of claim 1 wherein the basic dopant is selected from the group consisting of alkaline oxides, alkaline earth oxide, organic amine, ammonia, ammonium hydroxide and combinations thereof.

7. The doped, solid acid catalyst of claim 6 wherein the basic dopant is at least one oxide selected from the group consisting of lithium oxide, sodium oxide, potassium oxide, cesium oxide, magnesium oxide, calcium oxide, strontium oxide, barium oxide and combinations thereof.

8. The doped, solid acid catalyst of claim 6 wherein the basic dopant is at least one organic amine selected from the group consisting of methyl amine, ethylamine, ammonia, ammonium hydroxide and combinations thereof.

9. The doped, solid acid catalyst composition of claim 1 wherein noble metal comprises a Group VIII metal.

10. The doped, solid acid catalyst composition of claim 1 wherein the refractory binder is selected from the group consisting of fumed silica, colloidal silica, precipitated silica and combinations thereof.

11. The doped, solid acid catalyst composition of claim 1 wherein the basic dopant is present in an amount that will provide for less cracking in a hydrocarbon conversion process than a solid acid catalyst composition in an equivalent hydrocarbon conversion process that does not contain a basic dopant.

12. The doped, solid acid catalyst composition of claim 11 wherein the dopant is present in an amount of less than about 100 ppm.

13. The doped, solid acid catalyst composition of claim 11 wherein the hydrocarbon conversion process is selected from the group consisting of isomerization, catalytic cracking, hydroisomerization, alkylation, transalkylation and combinations thereof.

14. The doped, solid acid catalyst composition of claim 1 wherein the solid acid catalyst composition is in a particulate or shaped form.

15. The doped, solid acid catalyst composition of claim 14 wherein the shaped form is an extrudate.

16. A hydrocarbon conversion process comprising:
i) providing a doped solid acid catalyst composition comprising:
a. at least one solid acid catalyst,
b. at least one metal promoter for solid acid catalyst (a),
c. at least one basic dopant for solid acid catalyst (a),
d. at least one noble metal; and, optionally,
e. at least one refractory binder; and,
ii) contacting a hydrocarbon feed with said doped, solid acid catalyst composition under conversion reaction conditions, wherein the conversion reaction is selected from the group consisting of isomerization, catalytic cracking, hydrocracking, hydroisomerization, alkylation, transalkylation and combinations thereof.

17. The process of claim 16 wherein the hydrocarbon conversion process is isomerization.

18. The process of claim 17 wherein process of isomerization results in less cracking than an equivalent process of isomerization that comprises contacting a hydrocarbon feed with a solid acid catalyst composition other than doped, solid acid catalyst composition.

19. The process of claim 16 wherein hydrocarbon feed is a mixed stream of hydrocarbons.

20. The process of claim 16 wherein hydrocarbon feed is a mixed stream of hydrocarbons comprising monobranched and normal paraffins.

21. The process of claim 16 wherein the hydrocarbon feed is a mixed stream of hydrocarbons comprising monobranched and normal C₇ and/or C₈ hydrocarbons.

22. The process of claim 16 resulting in an isomerized product with an increased octane number.

23. The process of claim 16 wherein hydrocarbon feed is a Fischer-Tropsch process product.

24. A process of making a doped, solid acid catalyst composition comprising: combining
a. at least one solid acid catalyst,
b. at least one metal promoter for solid acid catalyst (a),
c. at least one basic dopant for solid acid catalyst (a),
d. at least one noble metal; and, optionally,
e. at least one refractory binder.

25. A hydrocarbon stream comprising the doped, solid acid catalyst composition of claim 1.

26. An isomerized product of claim 16, which has at least one of a reduced pour point, cloud point, or freeze point.
